(19) United States
(12) Patent Application Publication
(10) Pub. No.: US 2009/0161568 A1
(43) Pub. Date: Jun. 25, 2009

(54) TCP data reassembly

(76) Inventor: Charles Kastner, Manchester, MO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 12/004,791

(22) Filed: Dec. 21, 2007

(51) Int. Cl. G06F 11/00

(52) U.S. Cl. 370/252

(57) ABSTRACT

Method and apparatus for processing computer network data. An embodiment of the invention comprises a first device for receiving a stream of data, said stream comprising at least a first data frame, said first data frame having been sent from a second device 101 to a third device 201, the first data frame containing a payload section and at least one header section, the first device comprising: a TCP data reassembly apparatus 10 communicatively coupled to a monitoring application 16 and a memory 14. The TCP data reassembly apparatus 10 is adapted to receive the stream of data and classify the first data frame as containing one of a TCP/IP segment, a UDP/IP datagram, a non-TCP/UDP IP packet, and a non-IP packet; supply the monitoring application 16 with a copy of the first data frame and send the first data frame to the third device 201 from the first device 101 when the first data frame is classified as containing one of a non-TCP/UDP IP packet and a non-IP packet. The TCP data reassembly apparatus 10 is also adapted to check an associated UDP header checksum for validity when the first data frame is classified as containing a UDP/IP datagram and supply the monitoring application 16 with a copy of the first data frame and send the first data frame to the third device from the first device 101 when the UDP header checksum is valid. The TCP data reassembly apparatus 10 is further adapted to check an associated TCP header checksum for validity when the first data frame is classified as containing a TCP/IP segment, and send the first data frame to the third device 201 from the first device 101 and compare an actual TCP header sequence number with an expected TCP header sequence number when the associated TCP header checksum is valid; and supply the monitoring application 16 with a copy of the TCP/IP segment when no gap exists between the sequence number and the expected sequence number, and, store the first data frame in the memory 14 when a sequence gap exists between the actual TCP header sequence number and the expected TCP header sequence number.

### TECHNICAL FIELD

This invention relates generally to data transfer through a computer network and, more particularly, to the monitoring of data passing through the Internet.

### BACKGROUND OF THE INVENTION

Systems for monitoring and processing network packet data known in the art include those described by Scheuhler, et al., in U.S. patent application Ser. No. 10/222,307, published as US 2003/0177253 A1, “TCP-splitter: reliable packet monitoring methods and apparatus for high speed networks” (“Scheuhler I”) and in U.S. patent application Ser. No. 10/638,815, published as US 2004/0049596 A1, “Reliable packet monitoring methods and apparatus for high speed networks” (“Scheuhler II”), each of which is hereby incorporated by reference herein in its entirety. In brief, Scheuhler I describes a data monitoring system, implementable at high bandwidth rates, wherein a TCP-splitter receives and routes network packet data. Based on a set of processing rules, a data packet is (1) passed to an outbound IP stack only; (2) passed both to the outbound IP stack and to a client application; or (3) discarded (dropped). Advantageously, the client application has a monitoring capability whereby it has access to reference data and, in real time, compares the byte stream of data packets transferred to it from the TCP-splitter with the reference data to perform content matching. Exemplary techniques and devices for content matching usefully employed with the methods and apparatus of the present inventions are described in U.S. Pat. No. 7,093,023, “Methods, systems, and devices using reprogrammable hardware for high-speed processing of streaming data to find a redefinable pattern and respond thereto” and U.S. patent application Ser. No. 10/037,593, published as US 2003/0110229 A1, “System and method for controlling transmission of data packets over an information network”, each of which is hereby incorporated by reference herein in its entirety.

According to the disclosures referenced above, a TCP/IP data segment having an expected sequence number and a valid checksum is forwarded both to the outbound IP stack and to the client monitoring application for scanning, e.g., for content matches. Each non-TCP/IP data packet and each TCP/IP segment having a less than expected sequence number is sent only to the outbound IP stack (i.e., is not sent to the client application for scanning). Furthermore, the systems disclosed in the above-cited prior art handle a TCP/IP segment having a greater than expected sequence number by either dropping that TCP/IP segment or by permitting the segment to effectively overwrite the flow record, causing any data in the “sequence gap” to be delivered without being scanned. Thus, in the approach taken in the prior art, non-TCP/IP data is never scanned, whereas at least some TCP/IP data segments are either delivered to a destination without having been passed to the client application for scanning, or are dropped. To the extent that data cannot be scanned, security and control (e.g., of the transfer of copyrighted material) is compromised; to the extent that data is dropped, overall network efficiency and throughput is impaired.

Thus, a need exists for improved routing and reassembly of data streams, particularly where, as in the modem Internet, such streams contain high volumes of indeterminably sequenced data packets of diverse types.

### DISCLOSURE OF INVENTION

Method and apparatus for processing computer network data. An embodiment of the invention comprises a first device for receiving a stream of data, said stream comprising at least a first data frame, said first data frame having been sent from a second device 101 to a third device 201, the first data frame containing a payload section and at least one header section, the first device comprising: a TCP data reassembly apparatus 10 communicatively coupled to a monitoring application 16 and a memory 14. The TCP data reassembly apparatus 10 is adapted to receive the stream of data and classify the first data frame as containing one of a TCP/IP segment, a UDP/IP datagram, a non-TCP/UDP IP packet, and a non-IP packet; supply the monitoring application 16 with a copy of the first data frame and send the first data frame to the third device 201 from the first device 101 when the first data frame is classified as containing one of a non-TCP/UDP IP packet and a non-IP packet. The TCP data reassembly apparatus 10 is also adapted to check an associated UDP header checksum for validity when the first data frame is classified as containing a UDP/IP datagram, supply the monitoring application 16 with a copy of the first data frame, and send the first data frame to the third device from the first device 101 when the UDP header checksum is valid. The TCP data reassembly apparatus 10 is further adapted to check an associated TCP header checksum for validity when the first data frame is classified as containing a TCP/IP segment, send the first data frame to the third device 201 from the first device 101, and compare an actual TCP header sequence number with an expected TCP header sequence number when the associated TCP header checksum is valid; and supply the monitoring application 16 with a copy of the TCP/IP segment when no gap exists between the sequence number and the expected sequence number, and store the first data frame in the memory 14 when a sequence gap exists between the actual TCP header sequence number and the expected TCP header sequence number.

### BRIEF DESCRIPTION OF THE DRAWINGS

Features of the invention are more fully disclosed in the following detailed description of the preferred embodiments, reference being had to the accompanying drawings, in which:

FIG. 1a illustrates a TCP reassembly apparatus 10 coupled to networks 100, 200 in accordance with an embodiment of the invention.

FIG. 1b illustrates a TCP reassembly apparatus 10 coupled to networks 100, 200 in accordance with an embodiment of the invention.

FIG. 1c is a block diagram of a TCP reassembly apparatus 10 in accordance with an embodiment of the invention.

FIG. 2 illustrates implementation of a TCP reassembly apparatus 10 on an FPGA or other hardware device 19 in accordance with an embodiment of the invention.

FIG. 3 is a block diagram of a layered protocol wrapper 1 in accordance with an embodiment of the invention.

FIG. 4 illustrates processing of TCP/IP segments in accordance with an embodiment of the invention.

FIG. 5 illustrates memory record management in accordance with an embodiment of the invention,

FIG. 6 is a flow chart illustrating a method embodiment of the present invention.

Throughout the drawings, the same reference numerals and characters, unless otherwise stated, are used to denote like features, elements, components, or portions of the illustrated embodiments. Moreover, while the subject invention will now be described in detail with reference to the drawings, it is done so in connection with the illustrative embodiments. It is intended that changes and modifications can be made to the described embodiments without departing from the true scope and spirit of the subject invention as defined by the appended claims.

### DETAILED DESCRIPTION OF THE PREFERRED EMBODIMENTS

Specific exemplary embodiments of the invention will now be described with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. It will be understood that when an element is referred to as being “connected” or “coupled” to another element, it can be directly connected or coupled to the other element, or intervening elements may be present. Furthermore, “connected” or “coupled” as used herein may include wirelessly connected or coupled. It will be further understood that although the terms “first” and “second” are used herein to describe various elements, these elements should not be limited by these terms. These terms are used only to distinguish one element from another element.

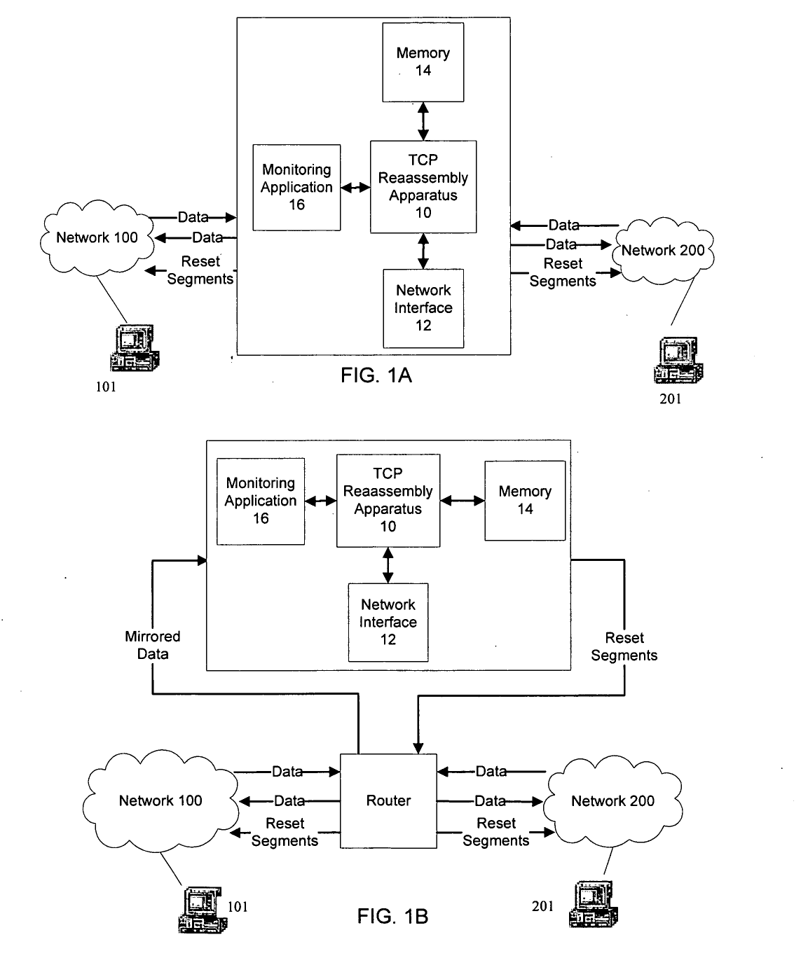

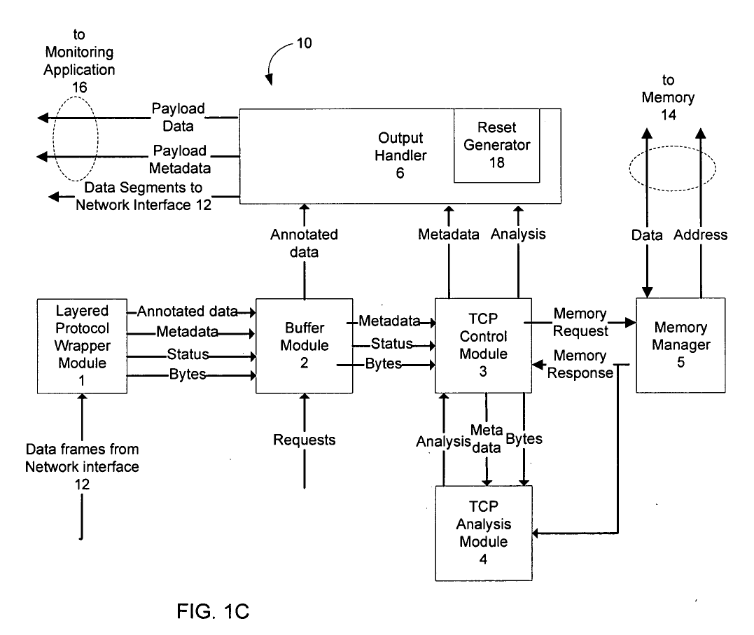

The invention provides for a flexible and high-performance transmission control protocol (TCP) reassembly apparatus operable to assist systems that monitor or otherwise process large amounts of network data. As illustrated in FIG. 1a, the TCP reassembly apparatus 10, together with a conventional network interface 12 (e.g., a PHYceiver or Network Interface Card), a memory 14, and a monitoring application 16 may be “in line” between a plurality of devices (e.g., computer workstations 101 and 201) communicatively coupled to respective networks (e.g., network 100 and network 200). Alternatively, TCP reassembly apparatus 10, together with network interface 12, memory 14, and monitoring application 16, may be implemented offline and used as a “passive tap” as shown in FIG. 1b. It is noted that memory 14 is shown as external to the TCP reassembly apparatus 10, but in some embodiments, memory 14 may be integrated within TCP reassembly apparatus 10.

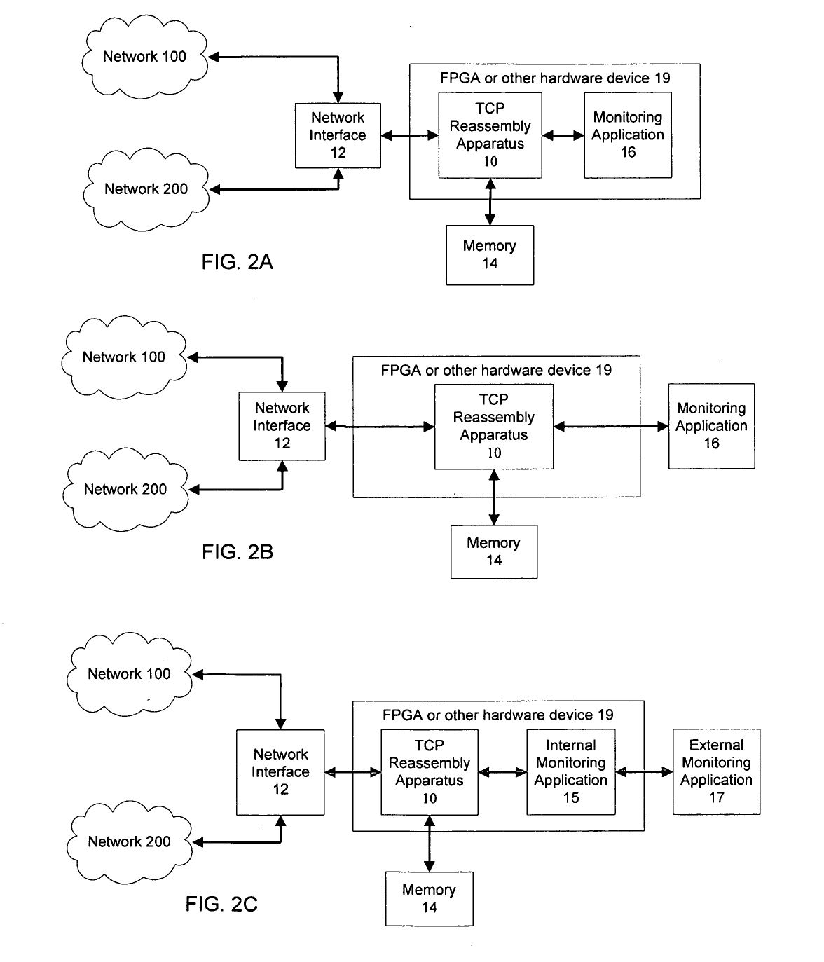

The apparatus and methods of the present invention may be implemented in a number of hardware schemes. For example, according to one embodiment of the invention, TCP reassembly apparatus 10 is compact enough to easily fit into reconfigurable hardware devices such as Field-Programmable Gate Arrays (FPGA's). Thereby, superior apparatus performance is provided, while permitting flexible adaptation of any of the apparatus's components to accommodate new features, environments and technology. Preferably, monitoring application 16 is packaged with TCP reassembly apparatus 10 on a single FPGA device 19 as illustrated in FIG. 2a. Where monitoring application 16 is not capable of fitting entirely on the FPGA device 19, the monitoring application 16 may be placed externally to FPGA device 19 as illustrated in FIG. 2b, or split so that monitoring is performed partially by internal monitoring application 15 implemented in FPGA 19 and partially by external monitoring application 17 implemented, as illustrated in FIG. 2c. Alternatively, an apparatus embodiment of the invention may be disposed in an application specific integrated circuit, resulting in a further improvement in performance at a cost of some reduction in flexibility.

An embodiment of the invention provides a stream of data bytes to a monitoring application 16 such that the data bytes are verified and correctly ordered for each TCP connection prior to being provided to the monitoring application 16. In an embodiment, a TCP reassembly apparatus 10 is placed on the same integrated circuit as the monitoring application 16. Such a configuration eliminates the need of repackaging the data and sending it across a bus or other transmission medium, thereby improving throughput, latency and reaction time.

Irrespective of the hardware implementation selected, the present invention increases the performance of monitoring application 16 by performing time-consuming TCP reassembly tasks upstream of monitoring application 16. At least when adapted for use in an FPGA 19, the present invention can be readily adapted to interface with virtually any required network interface 12 or monitoring application 16.

Referring to FIG. 1c, the overall architecture of the TCP reassembly apparatus 10 in accordance with an embodiment of the invention will now be described. TCP reassembly apparatus 10 may conveniently be organized into functional blocks, including layered protocol wrapper module 1, buffer module 2, TCP control module 3, TCP analysis module 4, memory manager 5, output handler 6 and memory 14.

A detailed description of each module, and the tasks performed therein, follows.

### Layered Protocol Wrapper Module 1

Referring still to FIG. 1c, layered protocol wrapper module 1 accepts data frames from an inbound network interface 12. The accepted data frames may be formatted in accordance with any data link layer protocol, e.g., Ethernet, ISDN, WLAN, etc., and will have an associated data link layer header. Depending on the nature of a particular data frame, the data frame may also include a succession of header sections in addition to a payload section and link layer header. For example, an IP (“network layer”) header section and a TCP (“transport layer”) header section may be present. Layered protocol wrapper module 1 processes each data frame through a sequence in which the data link layer header, and, if present, the network layer header and the transport layer header, are analyzed. Layered protocol wrapper module 1 marks the location within the data frame where each successive header begins, as well as the location where the payload section begins. Layered protocol wrapper module 1 also extracts metadata, or relevant information about the data frame, from the headers.

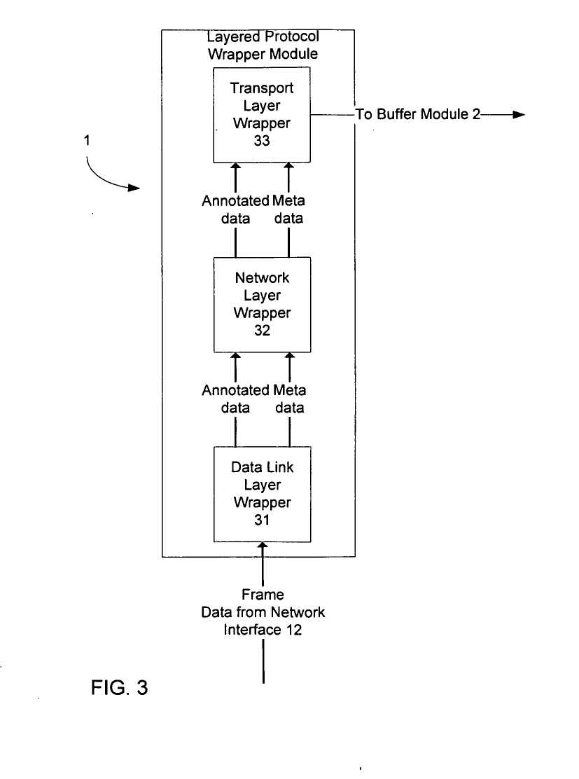

Conveniently, layered protocol wrapper module 1 includes a series of wrappers, as illustrated in FIG. 3. The first wrapper encountered by an incoming data frame is the data link layer wrapper 31, which receives data frames directly from an inbound network interface. Data link layer wrapper 31 provides subsequent wrappers (i.e., network layer wrapper 32 and transport layer wrapper 33) with the location where each data frame begins and ends, the location where the data frame's data link layer header section ends, whether any errors were detected by the data link wrapper 31 or at the network interface 12 (e.g., at the media access control sublayer) and what type of data follows the data link layer header section.

Other functions may also be performed by data link layer wrapper 31, because data link layer wrapper 31 may be adapted to accommodate different types of physical networks. For example, data link layer wrapper 31 may interface with an Ethernet network, a common standard in local area networks (LAN's). In this scenario, data link layer wrapper 31 may perform several functions. For example, data link layer 31 may extract, for subsequent use by the monitoring application 16, the source and destination hardware addresses contained in the frame header as well as network information and the type of data contained within the frame.

Following data link layer wrapper 31 is network layer wrapper 32, which receives annotated frame data and metadata from the data link layer wrapper 31. If the data frame contains an encapsulated IP packet, network layer wrapper 32 extracts data from an associated IP header, including source and destination IP addresses, the length of the packet payload and the transport layer protocol being used. Network layer wrapper 32 verifies the checksum present in the IP packet header, checks for other errors or deformities that may occur in the IP packet header, verifies that the packet's length is correct and informs transport layer wrapper 33 of where the packet's payload begins and ends.

If the data frame does not contain an encapsulated IP packet, the network layer wrapper 32 treats the data frame as a raw data link layer frame without any network or transport layer headers. The data frame may then be marked as such by the network layer wrapper 32.

The third and final protocol wrapper is the transport layer wrapper 33, which receives annotated packet data and metadata from the network layer wrapper 32. If the data frame does not contain an encapsulated TCP/IP segment or UDP/IP datagram, the transport layer wrapper 33 treats the packet as a raw network layer packet without any transport layer headers. The data frame may then be marked as such by the transport layer wrapper 33.

If the data frame contains a UDP/IP datagram, the transport layer wrapper 33 extracts the source and destination port identification data from the UDP header, identifies where the datagram's payload begins and ends, and verifies the length field and the checksum.

If the data frame instead contains a TCP/IP segment, the transport layer wrapper 33, in addition to the tasks described in the paragraph above, extracts a sequence number and several control bits providing additional information about the TCP/IP segment. The transport layer wrapper 33 may also compute a hash function over the TCP/IP segment's source and destination IP addresses and ports. The hash function transforms these portions of data into a smaller piece of data that will be used by subsequent components of the TCP reassembly apparatus 10.

### Buffer Module 2

Referring again to FIG. 1c, buffer module 2 may include a set of input buffers that are used to temporarily hold output from the layered protocol wrapper module 1. This is advantageous because, while initial processing in the layered protocol module 1 can be performed as quickly as data arrives from the network interface 12, subsequent processing operations utilize metadata extracted from various parts of the data frame and require the entire data frame to be checked for errors. As a data frame arrives and is processed and annotated by the protocol wrappers, both the annotated data and the metadata are stored in the buffers. Only when an entire data frame is annotated, checked for errors and stored in a buffer, can it be processed by the subsequent modules. Buffer module 2 also stores the last several bytes from each TCP/IP segment in a separate buffer. The usage of these bytes is detailed below.

Buffer module 2 also buffers requests sent to the TCP reassembly apparatus 10 by external applications that interface with the apparatus. Requests sent by these applications can modify the process by which the TCP reassembly apparatus 10 handles a particular connection. The TCP reassembly apparatus 10, for example, may accommodate commands to (1) “block” a connection, which involves dropping any packets from a connection that pass through it; (2) “kill” a connection, which involves sending a reset segment (see below) to both sides of the connection in order to actively shut down transmission of any subsequent data; (3) “allow” a connection, which allows data from a connection to pass without inspection; and/or (4) “hijack” a connection, which reroutes all data arriving from a connection to the monitoring application 16.

### TCP Control Module 3

TCP control module 3 dispatches data to and gathers data from several other modules and determines the subsequent routing of each data frame.

TCP control module 3 may operate in response to a request submitted by an external application, or may operate in accordance with a standing set of processing rules on data delivered from buffer module 2. If a request has been submitted, TCP control module 3 instructs memory manager 5 to retrieve a record from memory 14 corresponding to the connection that is subject to the submitted request. When the record is retrieved, TCP control module 3 updates the record in accordance with the request from the external application. When subsequent data frames from that connection arrive, action corresponding to the request is performed on them.

In addition to acting in accordance with requests submitted by an external application, TCP control module 3 is operable to accept and process data received from buffer module 2. TCP control module 3 may first check whether an error was detected during processing by the layered protocol wrapper module 1; if so, TCP control module 3 instructs the output handler 6 to “drop” the offending data frame. If the data frame does not contain a TCP/IP segment, TCP control module 3 instructs output handler 6 to pass the data frame in parallel streams to the network interface 12 and to the monitoring application 16 without further processing.

If a data frame contains a TCP/IP segment and no errors were detected, TCP control module 3 requests memory manager 5 to update memory 14 based on the nature of the TCP/IP segment and the state of an associated connection. For example, if the TCP/IP segment is a “SYN” segment, marking a first data segment in a connection, a record is created for the connection. For a TCP/IP segment that is not a SYN segment, TCP control module 3 requests memory manager 5 to retrieve a record from memory 14 corresponding to the connection associated with that TCP segment. Upon a successful lookup, the TCP control module 3 sends metadata regarding the TCP/IP segment and record data from memory manager 5 to TCP analysis module 4. TCP analysis module 4 performs a series of operations to determine whether the TCP/IP segment has an expected sequence number, and if not, how much it overlaps with data that has already been seen or how much further ahead the TCP/IP segment is compared to what is expected. TCP analysis module 4 also provides information on the state of the associated TCP/IP segment.

Based on information from TCP analysis module 4, the TCP control module 3 may rewrite an updated record to memory manager 5 and instruct the data buffer module 2 to send the TCP/IP segment to output handler 6 for further handling. This may involve erasing the connection record if the connection has been terminated.

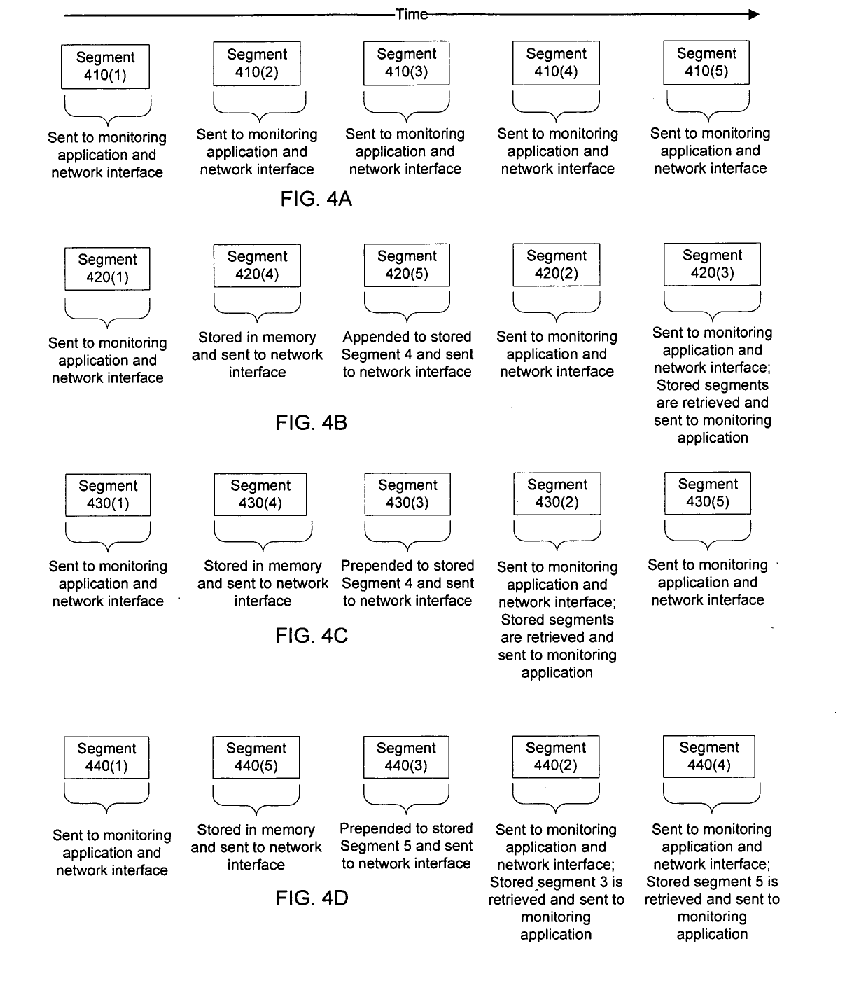

FIG. 4 illustrates the treatment of TCP/IP segments associated with a particular connection. As shown in FIG. 4a, when TCP/IP segments 410(1) through 410(5) arrive in sequential order, they are normally passed in parallel to network interface 12 and monitoring application 16 without being stored in memory 14. When a segment arrives that is further ahead than expected (i.e., a “sequence gap” exists between sequence numbers), as illustrated in FIGS. 4b and 4c, the segment is treated in the following manner. The out-of-order segment is passed to network interface 12, but, instead of being also sent to monitoring application 16, TCP control module 3 instructs memory manager 5 to store the TCP/IP segment data in memory 14 until subsequent TCP/IP segments close the sequence number gap. For example, in FIG. 4b, segment 420(4) is received out of order, with the result that a sequence gap exists between segment 420(1) and segment 420(4); segment 420(4), accordingly, is stored in memory 14. Multiple segments may be stored in memory 14 for each connection in the event that several segments arrive earlier than expected. Thus, still referring to FIG. 4b, when segment 420(5) arrives thereafter, it is appended to stored segment 420(4). When a sequence gap is filled (for example, when segment 420(3) arrives), all stored data contiguous to the filled sequence gap is removed from memory 14 and is sent to the monitoring application 16 in properly ordered sequence.

As a further example, FIG. 4c illustrates, similarly to FIG. 4b, that segment 430(4) is received out of order, with the result that a gap exists between segment 430(1) and segment 430(4). Segment 430(4), accordingly, is stored in memory 14. When segment 430(3) arrives thereafter, it is prepended to stored segment 430(4). When the sequence number gap is filled (for example, when segment 430(2) arrives, all of the stored data is sent to the monitoring application 16 in a properly ordered sequence.

Segments that are both further ahead than expected and non-contiguous with existing data in the storage region, as illustrated in FIG. 4d, are appended or prepended to stored segments based on their relative sequence numbers. Segment 440(3), for example, having a higher sequence number than expected but being non-contiguous with stored segment 440(5), is prepended to stored segment 440(5). When segment 440(2) arrives and closes the sequence gap between segment 440(1) and 440(3), segment 440(3) is removed from memory 14 and is sent to monitoring application 16 after segment 440(2). When segment 440(4) arrives and closes the sequence gap between segment 440(3) and 440(5), segment 440(5) is removed from memory 14 and is sent to monitoring application 16 after segment 440(4).

### Memory Manager 5

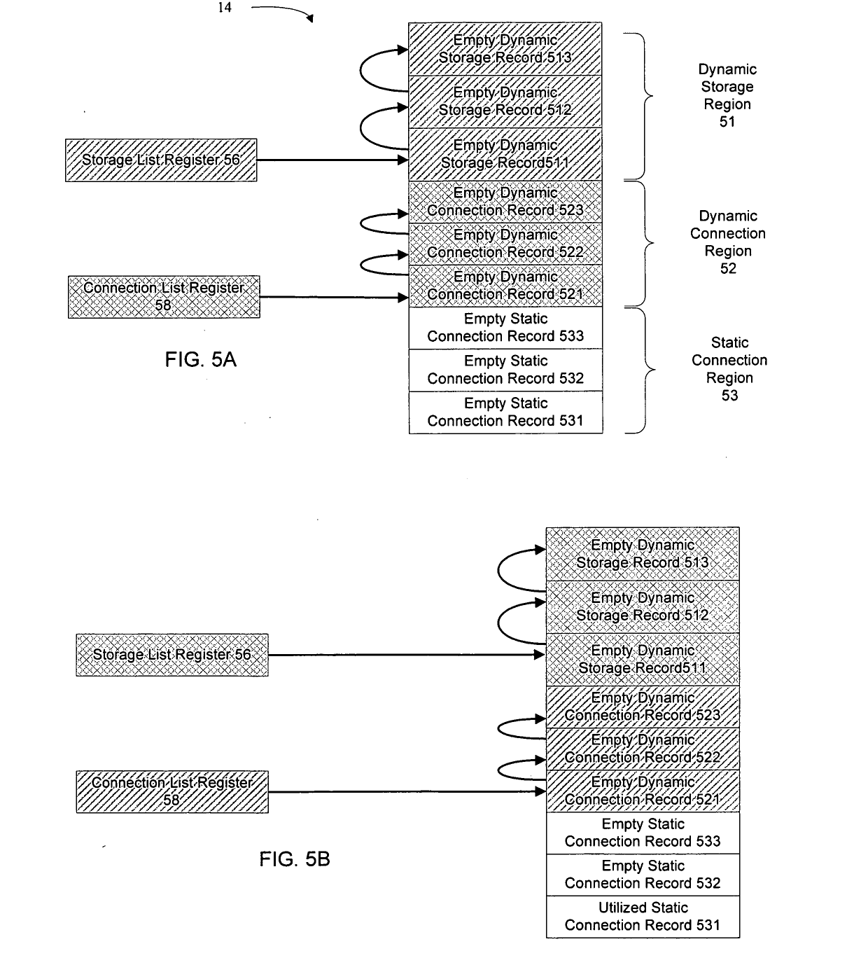

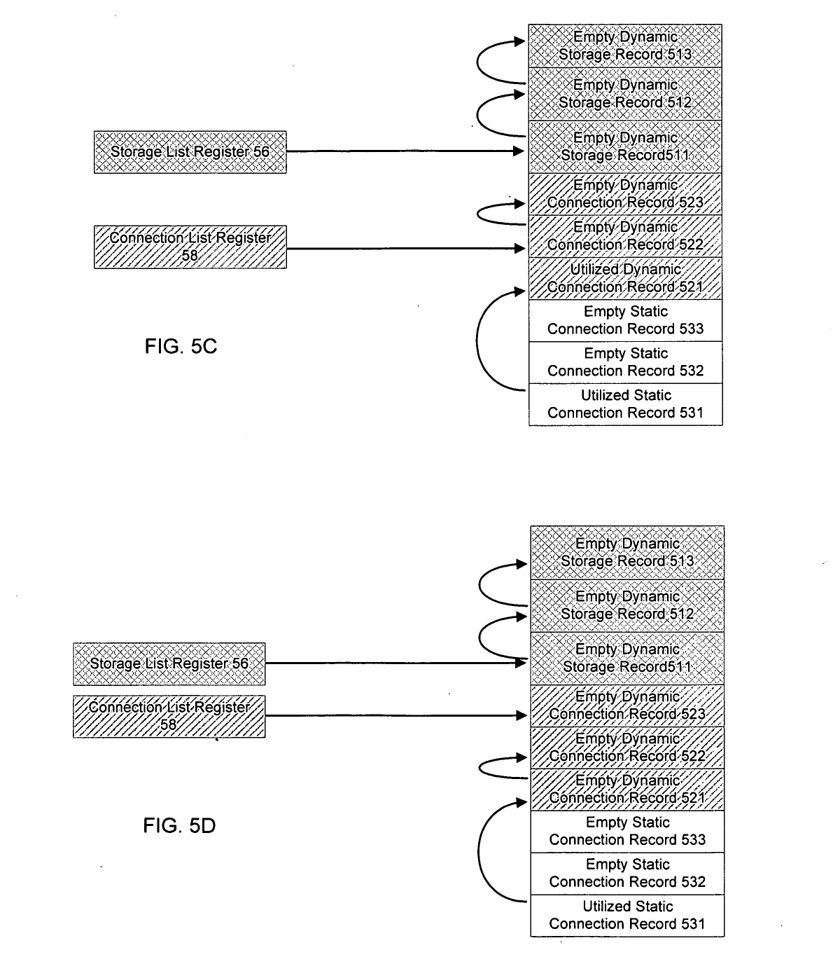

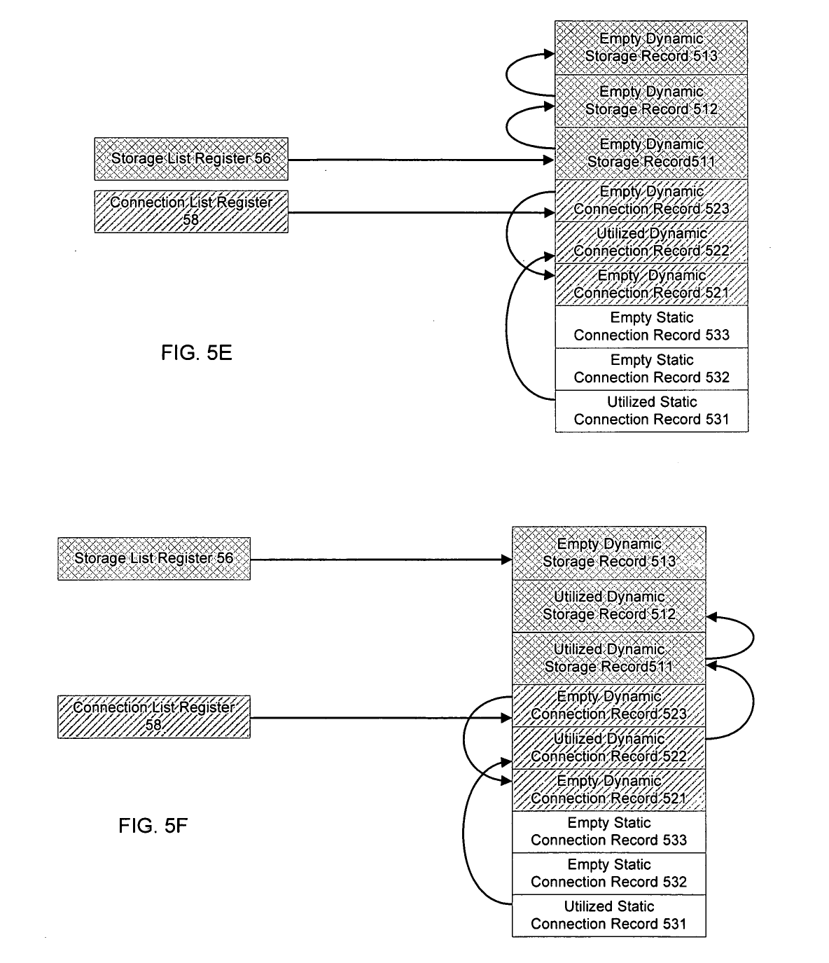

Memory manager 5 is responsible for handling memory access, relieving TCP control module 3 from this responsibility. As illustrated in FIG. 5a, memory manager 5 organizes memory 14 into three regions, each region having multiple records: (1) the dynamic storage region 51 which is utilized to store TCP/IP segments with sequence numbers further ahead than expected; (2) the dynamic connection region 52, which is utilized when more than one active connection results in the same hash value; and (3) the static connection region 53, which is addressable by hash values computed in the layered protocol wrapper module 1.

Records in both the dynamic storage region 51 and dynamic connection region 52 are retrieved by means of a free list, i.e., a list of unallocated memory records. The free lists for both record types are initialized by memory manager 5 upon startup. When a new dynamic record is needed, it is removed from the free list; when an in-use dynamic record is no longer needed, it is added back to the free list.

By way of example, FIGS. 5a-5f illustrate operation of memory 14 in accordance with an embodiment of the invention. In FIG. 5a, memory 14 is illustrated as being initialized to contain three empty static connection records (531, 532 and 533), three empty dynamic connection records (521, 522 and 523), and three empty dynamic storage records (511, 512 and 513). Storage list register 56 and connection list register 58, which may be located within memory manager 5, point, respectively, to the “head” of the dynamic storage free list and the dynamic connection free lists. As illustrated in FIG. 5a, the two “free lists” are initialized such that storage list register 56 and connection list register 58 point to the head entries in the lists (i.e., empty dynamic storage record 511 and empty dynamic connection record 521, respectively); the first entry in each list points to the second entry in the list (i.e., empty dynamic storage record 511 points to empty dynamic storage record 512 and empty dynamic connection record 521 points to empty dynamic connection record 522); and the second entry in the list points to the final entry in the list. (i.e., empty dynamic storage record 512 points to empty dynamic storage record 513 and empty dynamic connection record 522 points to empty dynamic connection record 523).

A static connection record within static connection region 53 of memory 14 may be tied to zero or more dynamic records through a method called chaining, illustrated in FIGS. 5b-5e. In FIG. 5b, a connection has been stored in the static connection region 53 at static connection record 531.

FIG. 5c, illustrates that, when a second connection has generated a hash value equal to one already used by another connection (e.g., at static connection record 531), memory manager 5 may “chain” a dynamic connection record (e.g., dynamic connection record 521) to the static connection record 531. Information on the second connection is stored in dynamic connection record 521, and the static connection record 531 is modified to “point” to dynamic connection record 521.

Subsequent TCP/IP segments from the second connection are thereby directed to the correct dynamic record. As illustrated in FIG. 5d, when subsequent active connections also result in the same hash value, additional dynamic connection records (e.g., 522) can be attached to the end of the chain; the length is limited only by the number of unused dynamic records.

FIG. 5e illustrates that, when the second connection has been closed (dynamic connection record 521 becomes empty), the static connection record 531 is modified to “point” to the third connection's dynamic connection record 522; and dynamic connection record 521 that was formerly utilized by the closed connection is added to the free list.

TCP/IP segments requiring storage in the dynamic storage region of memory 14 are handled in a similar fashion. When a TCP/IP segment needs to be stored in memory 14 (because its sequence number is further ahead than expected), a free dynamic storage record is located and chained to the record corresponding to the connection. When additional data is stored, new records can be added to the chain as needed. In FIG. 5f, for example, the third connection requires two storage records 511 and 512 to store data.

To prevent memory 14 from filling up with connections that do not terminate gracefully, the memory manager 5 may periodically sweep memory 14 with a replacement algorithm. Thus, records for connections that have not seen traffic for a specified period of time may be eliminated.

To access memory 14, TCP control module 3 sends a command to memory manager 5 along with an address, along with any supplemental information required by nature of the command.

If requested to look up a record corresponding to a TCP/IP segment, memory manager 5 uses the hash computed in the transport layer wrapper 33 to read a record from the static connection region. If the addresses and ports of the record do not match those of the segment, memory manager 5 will follow a chain (if one exists) to locate the proper record. If the proper record does not exist because the TCP/IP segment is the first for a connection, the memory manager 5 may create one.

Once a record is looked up, TCP control module 3 temporarily stores the record's address so that it does not need to be looked up again for the same TCP/IP segment. When TCP control module 3 performs an operation to update or delete connection records, or to access stored segments, it passes the record's actual address—rather than a hash value which may or may not be the record's actual address—to memory manager 5.

### TCP Analysis Module 4

TCP analysis module 4 performs calculations needed for the TCP control module 3 to make decisions about the proper handling of a TCP/IP segment. For example, the TCP analysis module 4 may determine whether or not the current segment should be ignored, sent to the monitoring application 16, or stored in memory 14, based on the current segment's sequence number and length, the expected sequence number for the connection, the starting sequence number of out-of-order segments stored in memory 14, and the amount of data stored in memory 14.

In the event of partial overlap between the current TCP/IP segment and data that has already been seen by the apparatus, TCP analysis module 4 determines which portion of the segment should not be stored in memory 14 or sent to monitoring application 16. If TCP/IP segments from the current connection are already stored in memory 14, TCP analysis module 4 determines whether the segment should be added before or after the segments already stored, whether any of the segment data overlaps with data already stored in memory 14, and whether there is room to store the segment in memory 14.

TCP analysis module 4 also determines whether the current segment should be the last for its particular connection, and if not, determines the expected sequence number for the connection's next TCP/IP segment.

TCP analysis module 4 also makes use of the last several bytes from the TCP/IP segment. These bytes are stored separately in buffer module 2, as noted above. When a TCP/IP segment is sent to monitoring application 16, the application can optionally be pre-loaded with the last several bytes from the connection's previous TCP/IP segment. Thereby, monitoring application 16 can scan for data that might be spread across multiple TCP/IP segments. The TCP analysis module 4 pushes data from the current segment into the set of stored recent bytes, while the bytes that had been stored from previous segments are sent out to the monitoring application 16. These most recent bytes are stored in memory 14 along with the connection's memory record for retrieval on a per-segment basis.

### Output Handler 6

The output handler 6 prepares and outputs two streams of data. The first stream contains data frames, each data frame of which is unmodified from its initial state, to be sent back to the originating network interface 12 for forwarding to the data frame's destination address. This first stream ordinarily includes every data frame received by layered protocol wrapper module 1 unless an error was detected somewhere in the data frame's contents or the data frame is associated with a connection that was “dropped,” “killed,” or “hijacked” by commands received by the TCP reassembly apparatus 10.

The second stream contains data sent to monitoring application 16, and consists of payload data without associated headers. This payload data can take the form of a TCP/IP segment payload, a UDP/IP datagram payload, a non-TCP/UDP IP packet payload or a non-IP link layer frame payload. The payloads are accompanied by a selection of relevant metadata pertaining to the data and, for TCP/IP segments, the connection to which they belong. TCP/IP segment payloads are also sent with a portion of connection data from prior segments, for use as described above. An exception to this format is when a connection is “hijacked.” In this case, the payload is sent along with its data link layer, network layer, and transport layer headers.

Output handler 6 is advantageously provided with a reset generator 18. Reset generator 18 may generate reset segments for connections that are “killed” by a request from monitoring application 16. A reset segment is a special type of TCP/IP segment that forcibly closes a connection. When a connection is killed, output handler 6 sends reset segments via network interface 12 to the hosts on either end of the connection. For additional protection, the output handler 6 may also replace any incoming segments from the connection with reset segments.

### Method Embodiment

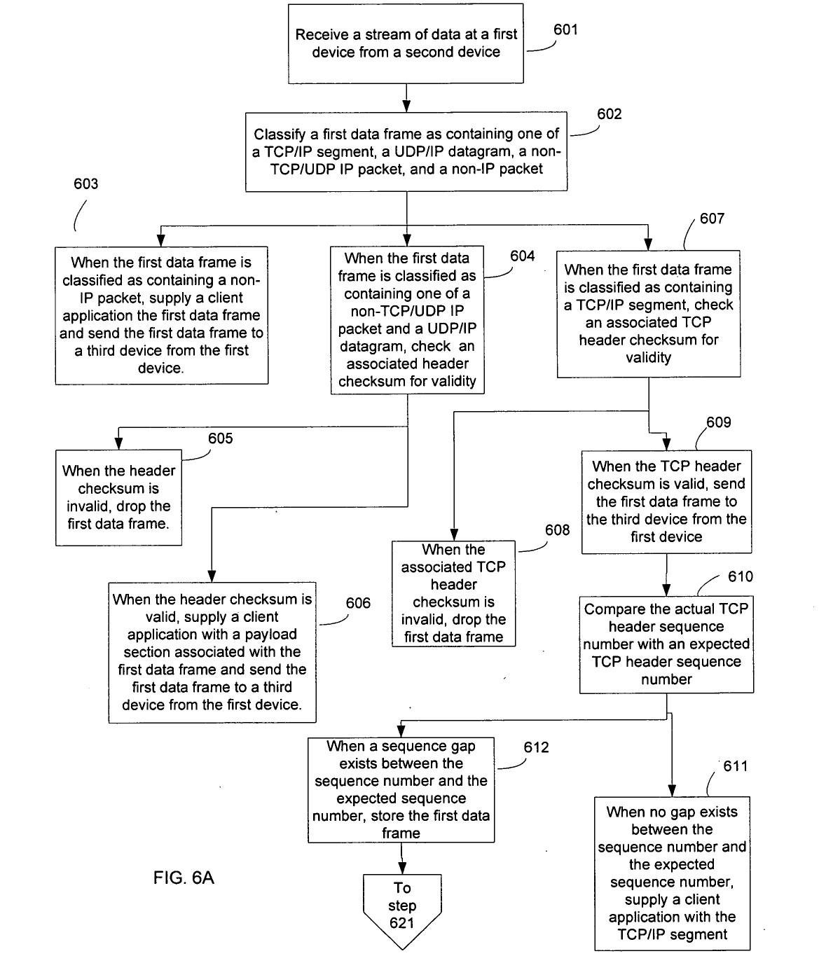

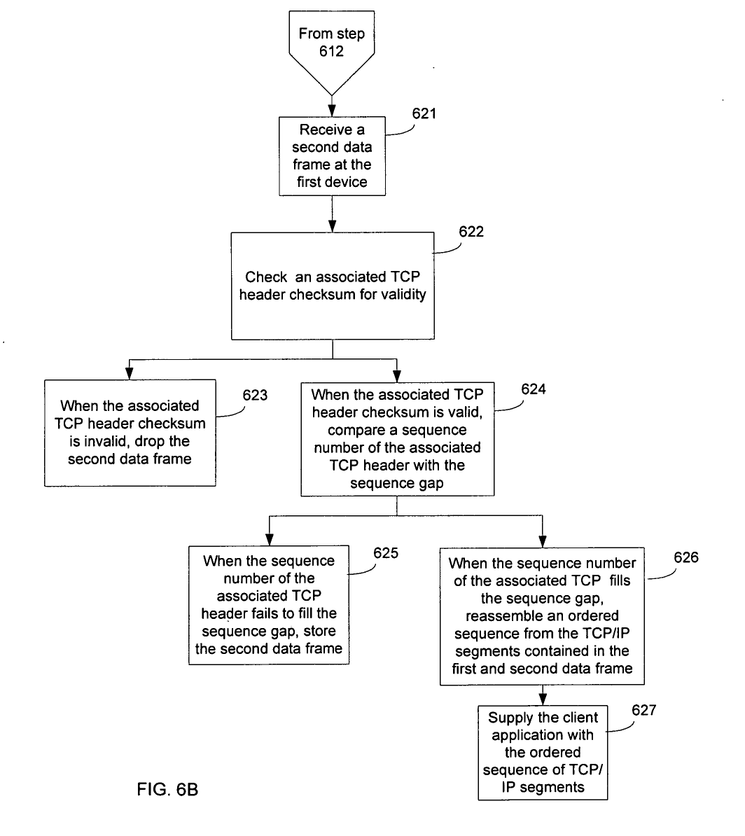

An exemplary method embodiment of the present invention will now be described with reference to FIGS. 6a and 6b. Referring to FIG. 6a, the method begins by receiving, in step 601, a stream of data at a first device. The stream of data contains at least a first data frame sent from a second device to a third device, and the first device is in a flow path between the second device and the third device. The first data frame contains a payload section and at least one header section.

The method continues by classifying, in step 602, the first data frame as containing one of a TCP/IP segment, a UDP/IP datagram, a non-TCP/UDP IP packet, and a non-IP packet. In step 603, when the first data frame is classified as containing one of a non-TCP/UDP IP packet and a non-IP packet, a monitoring application 16 is supplied with a copy of the first data frame and the first data frame is sent to the third device from the first device.

In step 604, when the first data frame is classified as containing a UDP/IP datagram, an associated UDP header checksum is checked for validity. In step 605, when the UDP header checksum is invalid, the first data frame is dropped. In step 606, when the UDP header checksum is valid, a monitoring application is supplied with a copy of UDP/IP datagram, and the first data frame is sent to the third device from the first device.

In step 607, when the first data frame is classified as containing a TCP/IP segment, an associated TCP header checksum is checked for validity. In step 608, when the associated TCP header checksum is invalid, the first data frame is dropped. In step 609, when the TCP header checksum is valid, the first data frame is sent to the third device from the first device. In step 610, the actual TCP header sequence number is compared with an expected TCP header sequence number. In step 611, when no gap exists between the sequence number and the expected sequence number, a monitoring application 16 is supplied with a copy of the TCP/IP segment. Step 612 stores the first data frame when a sequence gap exists between the sequence number and the expected sequence number.

Referring now to FIG. 6b, the method may continue by receiving, at step 621, a second data frame at the first device. The second data frame is sent from the second device to the third device, and contains a TCP/IP segment and an associated TCP header.

In step 622, a header checksum in the associated TCP header is checked for validity. In step 623, when the header checksum in the associated TCP header is invalid, the second data frame is dropped. In step 624, when the header checksum in the associated TCP header is valid, a sequence number of the associated TCP header is compared with the sequence gap.

In step 625, the second data frame is stored when the sequence number of the associated TCP header fails to fill the sequence gap. In step 626, an ordered sequence is reassembled from the TCP/IP segments contained in the first and second data frame when the sequence number of the associated TCP header fills the sequence gap and, in step 627, the monitoring application 16 is supplied with the ordered sequence of TCP/IP segments.

### Configuration Options

Because different applications that may utilize the high-performance TCP reassembly apparatus 10 of the present invention will differ in their exact system configurations, the apparatus contains a number of configuration options that can be set by the external monitoring application 16, as discussed herebelow.

For example, in one embodiment, TCP reassembly apparatus 10 can be placed either in a “passive tap” or an “active” mode. In active mode, TCP reassembly apparatus 10 can actively block TCP/IP segments from a specified connection by simply not sending them back to the network interface 12. Furthermore, segments that are dropped by the TCP reassembly apparatus 10 because the input buffer fills up or because there is not enough storage room for out-of-order segments belonging to a particular connection will never arrive at their destination, forcing a retransmission of the segments.

In passive tap mode, TCP reassembly apparatus 10 is sent only copies of frames traveling across a network. Although it may be able to inject data (such as reset segments) into the network, the apparatus is not enabled to actively block frames. If a TCP/IP segment is dropped because the input buffer fills up or because there is not enough storage room for out-of-order segments, the segment may be irrevocably lost by the apparatus and disrupt monitoring of the connection. Although passive tap mode is less robust than active mode, it is also less disruptive, because if the apparatus fails in active mode, it can block the flow of all traffic in and out of a network.

As mentioned above, the TCP reassembly apparatus 10 will not ordinarily record information on connections that it cannot monitor from start to end. Monitoring applications may not be able to make sense of such data, and without a starting sequence number the TCP reassembly apparatus 10 cannot know if a TCP/IP segment arriving from such a connection will be followed by other out-of-order segments with lower sequence numbers. Thus, timely reassembly is made difficult without consuming large amounts of resources. For purposes such as statistics keeping, however, a monitoring application may be interested in seeing all TCP/IP segments from a connection.

The foregoing merely illustrates principles of the invention. It will thus be appreciated that those skilled in the art will be able to devise numerous systems and methods which, although not explicitly shown or described herein, embody said principles of the invention and are thus within the spirit and scope of the invention as defined by the following claims.

What is claimed is:

1. A method for processing computer network data, said method comprising the steps of:
receiving a stream of data at a first device, said stream comprising at least a first data frame, said first data frame having been sent from a second device to a third device, and said first data frame containing a payload section and at least one header section;
classifying the first data frame as containing one of a TCP/IP segment, a UDP/IP datagram, a non-TCP/UDP IP packet, and a non-IP packet;
supplying a monitoring application with a copy of the first data frame and sending the first data frame to the third device from the first device when the first data frame is classified as containing a non-IP packet;
checking an associated header checksum for validity when the first data frame is classified as containing one of a UDP/IP datagram and non-TCP/UDP IP packet, supplying a monitoring application with a copy of a payload section associated with the first data frame, and sending the first data frame to the third device from the first device when the UDP header checksum is valid; and
checking an associated TCP header checksum for validity, when the first data frame is classified as containing a TCP/IP segment, and sending the first data frame to the third device from the first device and comparing an actual TCP header sequence number with an expected TCP header sequence number when the TCP header checksum is valid, and,
supplying the monitoring application with a copy of the TCP/IP segment when no gap exists between the actual TCP header sequence number and the expected TCP header sequence number, and
storing the first data frame when a sequence gap exists between the actual TCP header sequence number and the expected TCP header sequence number.

2. The method of claim 1, further comprising:
receiving at the first device a second data frame, said second data frame having been sent from the second device to the third device, and said second data frame comprising a TCP/IP segment and an associated TCP header;
checking a header checksum in the associated TCP header for validity and comparing a sequence number of the associated TCP header with the sequence gap when the header checksum in the associated TCP header is valid; and,
storing the second data frame when the sequence number of the associated TCP header fails to fill the sequence gap; and,
supplying the monitoring application with an ordered sequence of TCP/IP segments when the sequence number of the associated TCP header fills the sequence gap, said ordered sequence being reassembled from the TCP/IP segments contained in the first and second data frame.

3. Apparatus for processing computer network data, said apparatus comprising:
a first device for receiving a stream of data, said stream comprising at least a first data frame, said first data frame having been sent from a second device to a third device, the first data frame containing a payload section and at least one header section, the first device comprising:
a TCP data reassembly apparatus communicatively coupled to a monitoring application and a memory, said TCP data reassembly apparatus adapted to
receive the stream of data and classify the first data frame as containing one of a TCP/IP segment, a UDP/IP datagram, a non-TCP/UDP IP packet, and a non-IP packet;
supply the monitoring application with a copy of the first data frame and send the first data frame to the third device from the first device when the first data frame is classified as containing one of a non-TCP/UDP IP packet and a non-IP packet;
check an associated header checksum for validity when the first data frame is classified as containing one of a UDP/IP datagram and non-TCP/UDP IP packet, supply the monitoring application with a copy of a payload section associated with the first data frame, and send the first data frame to the third device from the first device when the UDP header checksum is valid; and
check an associated TCP header checksum for validity when the first data frame is classified as containing a TCP/IP segment, and send the first data frame to the third device from the first device and compare an actual TCP header sequence number with an expected TCP header sequence number when the associated TCP header checksum is valid; and
supply the monitoring application with a copy of the TCP/IP segment when no gap exists between the sequence number and the expected sequence number, and,
store the first data frame in the memory when a sequence gap exists between the actual TCP header sequence number and the expected TCP header sequence number.

4. The apparatus of claim 3, wherein the TCP data reassembly apparatus is further adapted to
receive a second data frame, said second data frame having been sent from the second device to the third device, said second data frame comprising a TCP/IP segment and an associated TCP header;
check a header checksum in the associated TCP header for validity and drop the second data frame when the header checksum in the associated TCP header is invalid;
compare a sequence number of the associated TCP header with the sequence gap when the header checksum in the associated TCP header is valid; and,
store the second data frame in the memory when the sequence number fails to fill the sequence gap; and
supply the monitoring application with an ordered sequence of TCP/IP segments when the sequence number of the associated TCP header fills the sequence gap, said ordered sequence being reassembled from the TCP/IP segments contained in the first and second data frame.

5. The apparatus of claim 3, wherein the first device is in a flow path between the second device and the third device.

6. The apparatus of claim 3, wherein the first device operates as a passive tap of a flow path between the second device and the third device.

7. The apparatus of claim 3, wherein the TCP data reassembly apparatus is further adapted to receive and implement commands from an external application.

8. The apparatus of claim 7, wherein the TCP data reassembly apparatus, responsive to a command from the external application, is adapted to block any packets from a connection.

9. The apparatus of claim 7, wherein the TCP data reassembly apparatus, responsive to a command from the external application, is adapted to send a reset segment operable to shut down transmission of any subsequent data between the second device and the third device.

10. The apparatus of claim 7, wherein the TCP data reassembly apparatus, responsive to a command from the external application, is adapted to allow disabling inspection of data between the second device and the third device.

11. The apparatus of claim 7, wherein the TCP data reassembly apparatus, responsive to a command from the external application, is adapted to reroute all data arriving from at least one of the first device and the second device to the monitoring application.
